(19) United States
(12) Patent Application Publication
(10) Pub. No.: US 2005/0216228 A1
(43) Pub. Date: Sep. 29, 2005

(54) Method and system for correcting a fault in a semiconductor manufacturing system

(75) Inventors: Eric Kauffman, Austin, TX (US); Paul Brown, Austin, TX (US)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Minato-ku (JP)

(21) Appl. No.: 10/799,879

(22) Filed: Mar. 15, 2004

(51) Int. Cl. G06F 17/60

(52) U.S. Cl. 702/182; 705/7

(57) ABSTRACT

A method and system for correcting a fault in a semiconductor manufacturing system is described. Fault correction for a service component is achieved using an interactive case study with a service operator. The interactive case study can identify one or more cases where the current service activity data substantially matches past service activity data, and utilize this correlation to assist the service operator in conducting the service component repair. If necessary, the interactive case study can identify one or more tests to perform in order to narrow down the number of matching cases. As tests are performed and results are retrieved by the interactive case study, the number of matching cases is reduced. For instance, the interactive case study can assist in identifying a manufacturing system part to replace in a manufacturing system tool in order to correct the problem.

### CROSS-REFERENCE TO RELATED APPLICATION

This application is related to co-pending U.S. patent application Ser. No. 10/XXX,XXX, entitled “Activity management system and method of using”, Attorney docket no. 250049US6 YA/TEA-011, filed on Mar. 15, 2004. The entire contents of this application are herein incorporated by reference in their entirety.

### BACKGROUND OF THE INVENTION

1. Field of the Invention

The present invention relates to a method and system for correcting a fault in a semiconductor manufacturing system, and, more particularly, to a method of correcting a fault using an interactive case study with a service operator.

2. Description of Related Art

Maintaining a semiconductor manufacturing facility is a time-consuming and expensive procedure that involves collaboration between equipment manufacturers and the manufacturing facility. The inefficient interaction between a semiconductor equipment manufacturer and a semiconductor manufacturing facility can result in facility downtimes that add to the overall operational cost, as well as excessive consumption of engineering time and hardware replacements.

In the electronics industry, equipment manufacturers utilize a number of separate, independent service models configured to address activities ranging from manufacturing system maintenance, to manufacturing system trouble-shooting, to hardware replacement and approval, to part replacement and approval, etc. As a result, these service models exhibit a lack of communication of data between one another, significant overlap leading to redundancies, as well as establishing virtual boundaries within the structure designed to facilitate equipment service. The present inventors have recognized that this use of independent service models leads to increased service costs and reduced operating efficiency.

### SUMMARY OF THE INVENTION

Accordingly, one aspect of the present invention is to reduce or eliminate any or all of the above-described problems.

Another object of the present invention is to reduce service costs and maximize operating efficiency in the maintenance of a semiconductor manufacturing facility.

Yet another object of the present invention is to provide a system for isolating and/or correcting a fault in a semiconductor manufacturing system.

These and or other objects of the present invention are provided by a method of correcting a fault in a process tool for semiconductor manufacturing is. The method includes collecting old service activity data for old faults in the process tool, receiving new service activity data for a new fault in the process tool and comparing the new service activity data to the old service activity data. Matching service activity data is then identified from the comparison, and a corrective action is performed based on the matching service activity data.

According to another aspect, a system for correcting a fault in a process tool for semiconductor manufacturing includes a control system configured to collect old service activity data for old faults in the process tool, receive new service activity data for a new fault in the process tool, compare the new service activity data to the old service activity data. The control system identifies matching service activity data from the comparison, and performs a corrective action based on the matching service activity data in order to alleviate the new fault in the process tool.

Still another aspect of the invention is a computer readable medium containing program instructions for execution on a processor, which when executed by the processor, cause a computer system to perform the steps in the method recited in the claimed method.

Yet another aspect of the invention is a system for correcting a fault in a process tool for semiconductor manufacturing. The system includes means for collecting old service activity data for old faults in the process tool; means for receiving new service activity data for a new fault in the process tool; means for comparing the new service activity data to the old service activity data; means for identifying matching service activity data from the comparison; and means for performing a corrective action based on the matching service activity data.

### BRIEF DESCRIPTION OF THE DRAWINGS

In the accompanying drawings:

FIG. 1 presents a schematic diagram of a processing system according to an embodiment of the invention;

FIG. 2A illustrates an exemplary operator interface for accessing a service function;

FIG. 2B illustrates another exemplary operator interface for performing the service function depicted in FIG. 2A;

FIG. 2C illustrates another exemplary operator interface for performing the service function depicted in FIG. 2A;

FIG. 2D illustrates another exemplary operator interface for performing the service function depicted in FIG. 2A;

FIG. 2E illustrates another exemplary operator interface for performing the service function depicted in FIG. 2A;

FIG. 2F illustrates another exemplary operator interface for performing the service function depicted in FIG. 2A;

FIG. 2G illustrates another exemplary operator interface for performing the service function depicted in FIG. 2A;

FIG. 2H illustrates another exemplary operator interface for performing the service function depicted in FIG. 2A;

FIG. 21 illustrates another exemplary operator interface for performing the service function depicted in FIG. 2A;

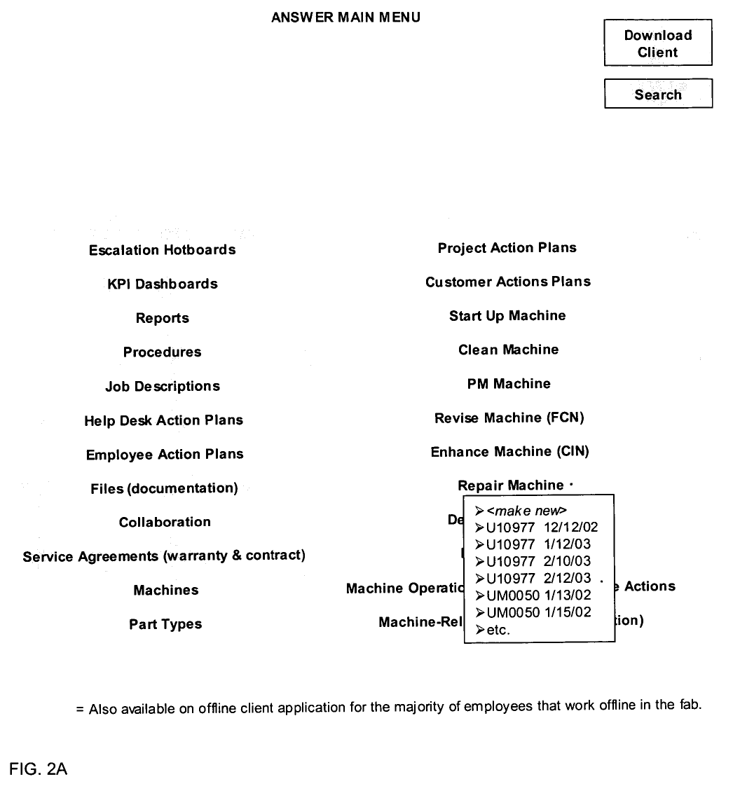

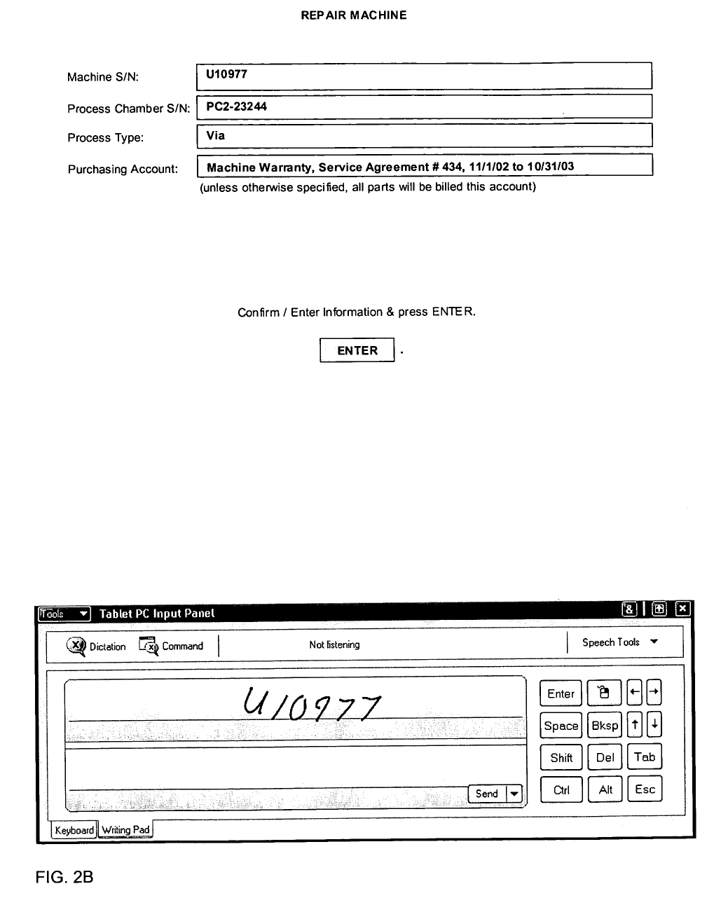

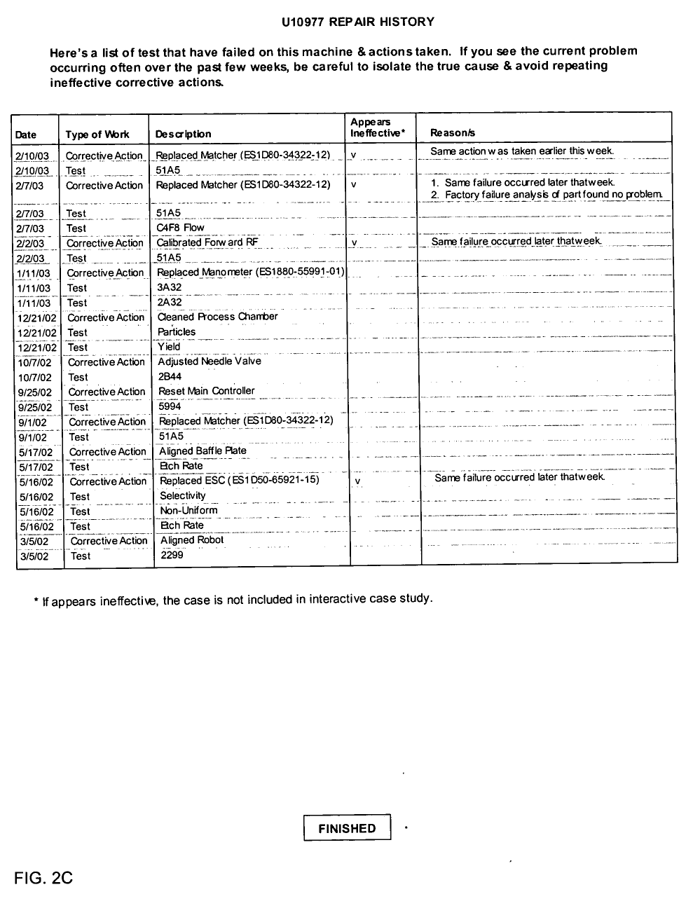

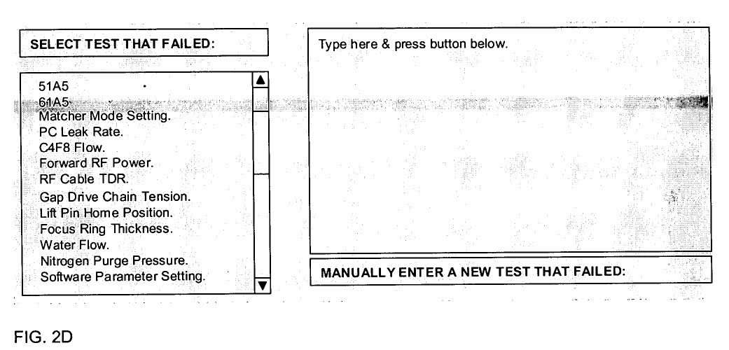

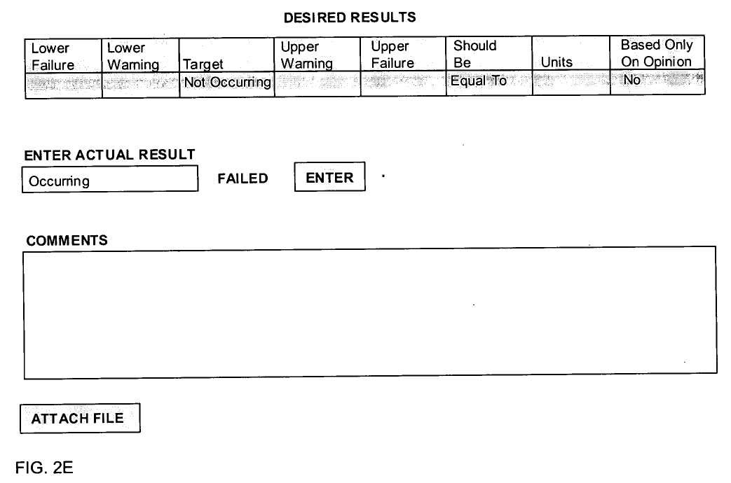

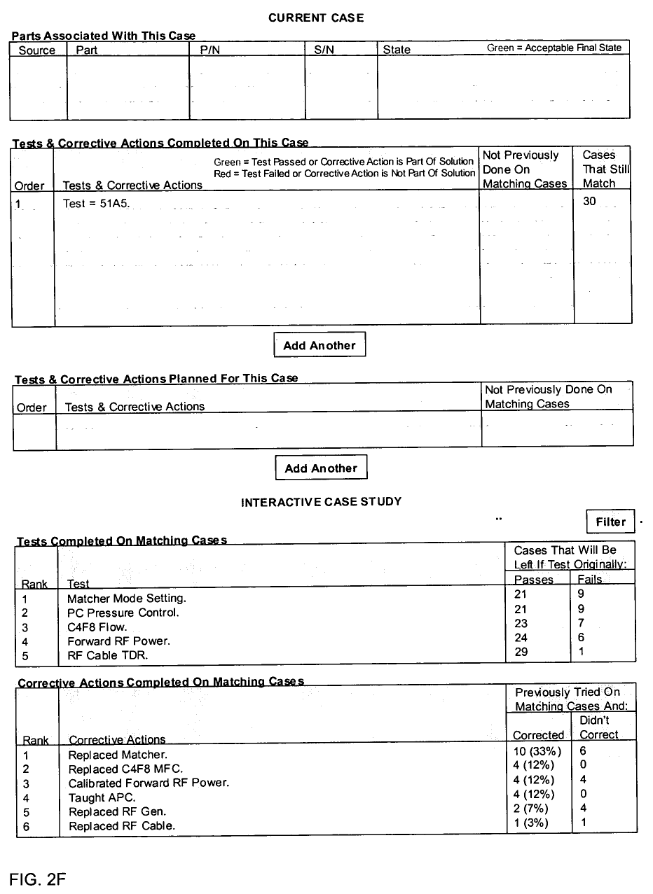

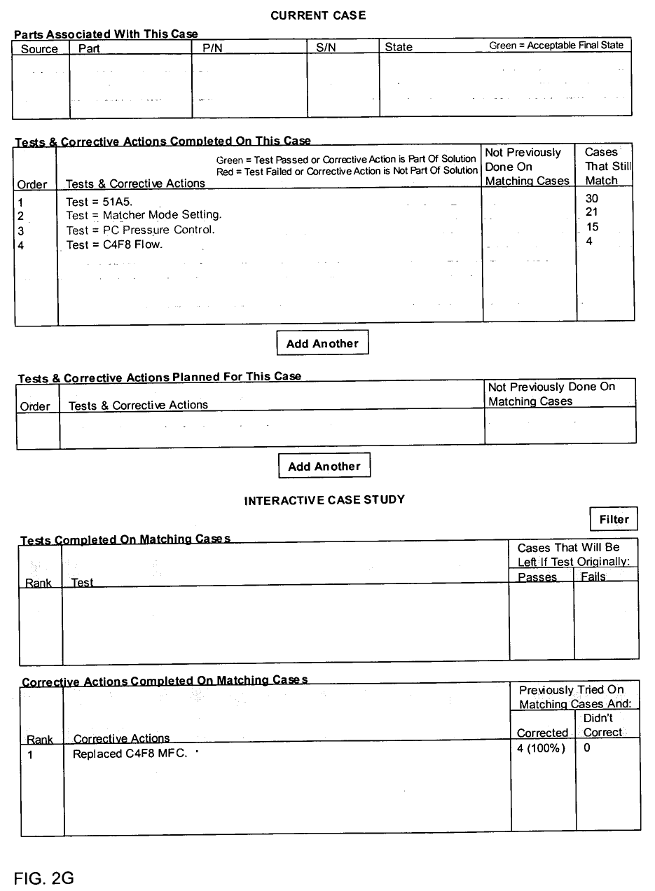

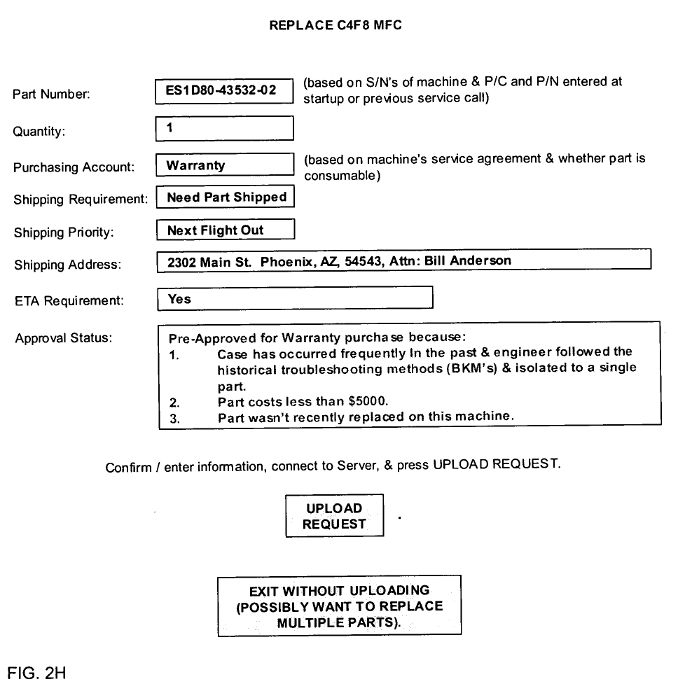

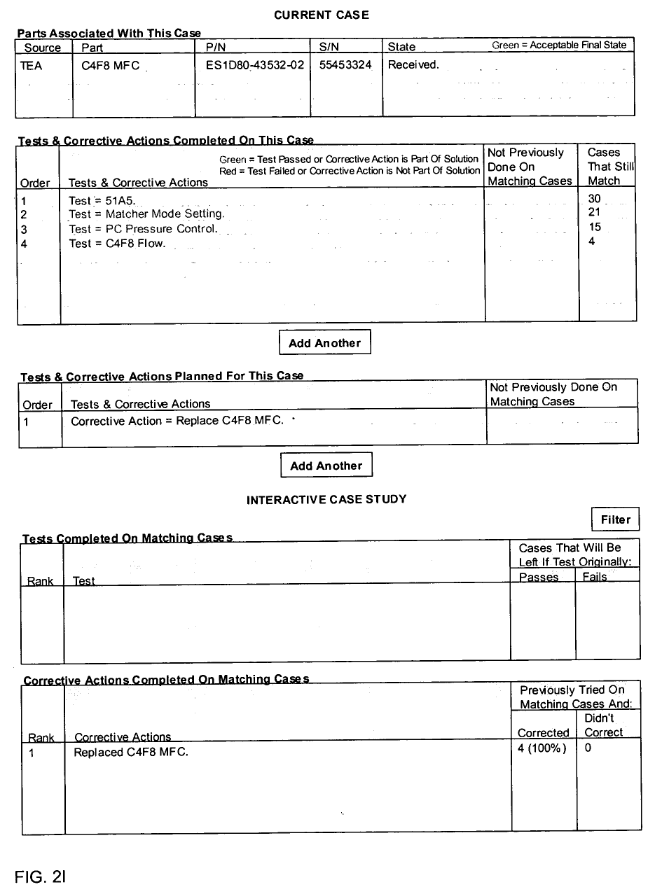

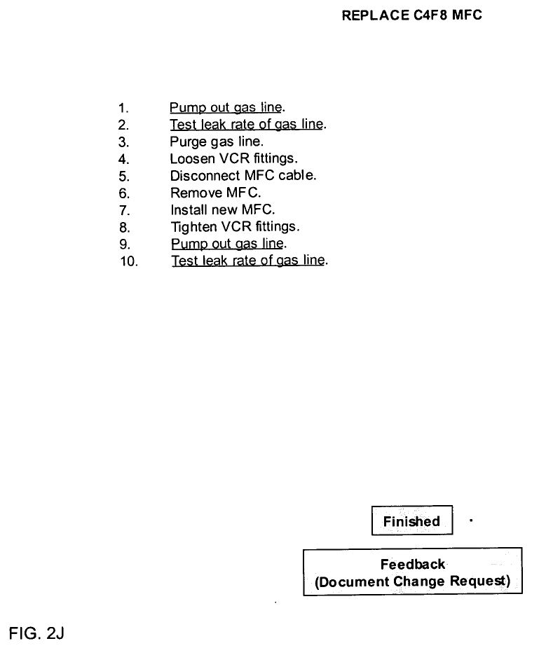

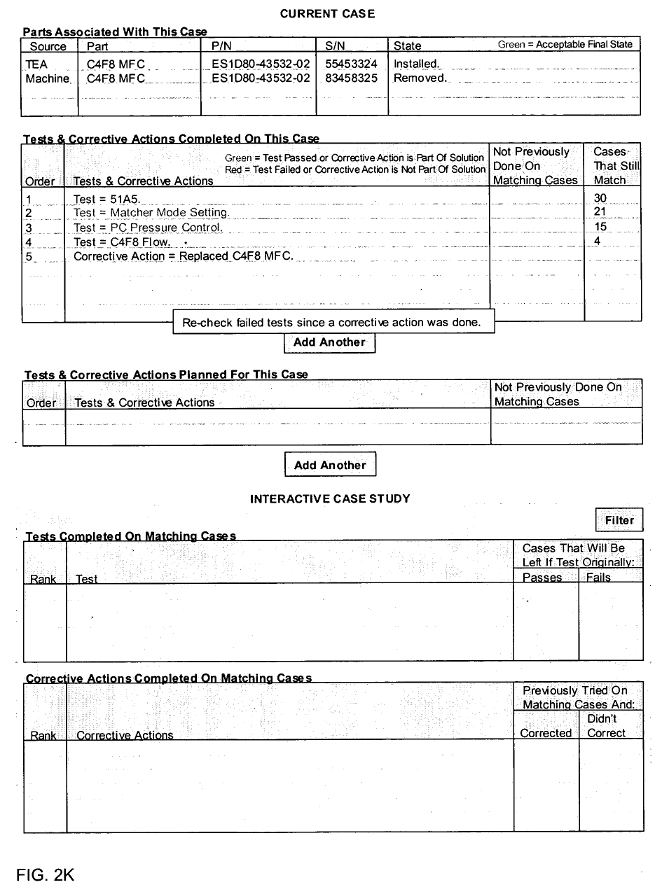

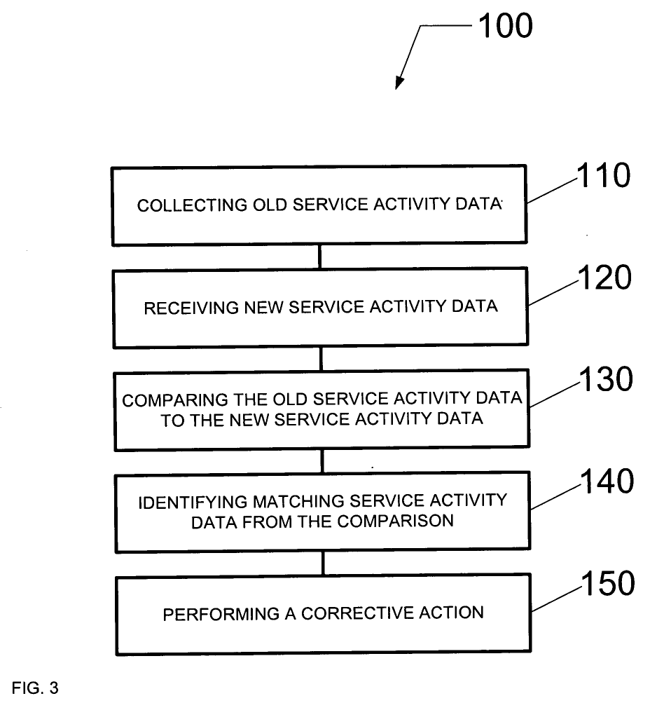

FIG. 2J illustrates another exemplary operator interface for performing the service function depicted in FIG. 2A;

FIG. 2K illustrates another exemplary operator interface for performing the service function depicted in FIG. 2A;

FIG. 3 shows a method of correcting a fault in a processing system according to another embodiment of the invention; and

FIG. 4 illustrates a computer system upon which an embodiment of the present invention may be implemented.

### DETAILED DESCRIPTION OF EXEMPLARY EMBODIMENTS

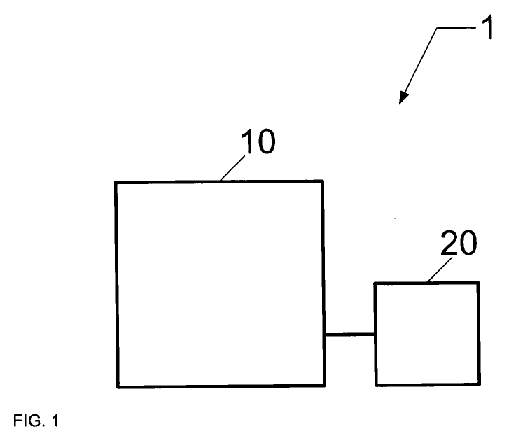

Referring now to the drawings wherein like reference numerals designate identical or corresponding parts throughout the several views, FIG. 1 presents a processing system 1 for semiconductor manufacturing. The processing system 1 includes a process tool 10 configured to perform a process on a substrate, and a control system 20 coupled to the process tool 10 and configured to perform a service function for correcting the process tool 10 using the service activity data. The service function performed by the control system may provide service action data useful to a service operator in correcting a fault in the process tool 10, or may provide automatic control of the process tool in order to correct the fault. According to one embodiment, the control system 20 stores service activity data used to perform service functions and correct a fault in the process tool 10.

The control system 20 can be directly coupled to the process tool 10, or it may be coupled to the process tool 10 via a local intranet within, for instance, a semiconductor manufacturing facility, or material processing facility. Additionally, the control system 20 can be coupled to the process tool 10 via at least one of an internet connection, and an intranet connection. Alternatively, the control system 20 can be a standalone control system, wherein the standalone control system is configured to receive service activity data via at least one of manual entry, and a data medium, such as a floppy disk, a magnetic tape, an optical disk, or a flash drive.

Referring still to FIG. 1, the processing system 1 can further include an operator interface (not shown) coupled to the control system 10. For example, the operator interface can include a graphical user interface (GUI). A GUI enables the control system 20 to perform at least one of collecting service activity data, correcting a fault, and providing service action data to assist a service operator in correcting a fault. As used herein “correcting the fault” includes providing of data or performing an action as an intermediate step to complete correction of a fault. Thus, correcting a fault may be providing data to a service operator that assists in troubleshooting a process tool, or isolating a fault to a limited number of causes. Those skilled in the art will recognize that GUI screens can comprise a selection tabs structure and/or a navigation tree structure. Additionally, as part of the interface, a keyboard, a mouse, a touch-screen, or any combination thereof can be provided.

The process tool can, for example, include a manufacturing system (MS) tool coupled to a manufacturing system (MS) platform. For example, the MS platform can include a cluster-tool arrangement, such as a Unity II, a Unity IIe, a Unity M, or a Unity ME, or a serial tool arrangement, such as a Telius platform, for performing semiconductor manufacturing processes, which are commercially available from Tokyo Electron Limited (TBS Broadcast Center, 3-6 Akasaka 5-chome, Minato-ku, Tokyo 107-8481). Additionally, for example, the MS platform can include an ACT 8, ACT 12, or Lithius Track System commercially available from Tokyo Electron Limited. Additionally, for example, the MS platform can include an Alpha Series, or TELFormula batch processing Thermal Processing System commercially available from Tokyo Electron Limited. Additionally, for example, the MS platform can include a Trias Deposition System commercially available from Tokyo Electron Limited. The MS tool can, for example, include a DRM, A-DRM, DRM II, SCCM-DT, SCCM-Ox, or SCCM-Poly Etch System, or a SPA Deposition System. More generally, the MS tool can, for example, include an etch system; a deposition system such as a thermal deposition system, a chemical vapor deposition (CVD) system, an atomic layer deposition (ALD) system, a physical vapor deposition (PVD) system, or an ionized PVD (I-PVD) system; a photoresist spin coating system; a spin-on dielectric system; a cleaning system such as a liquid immersion system or a supercritical fluid cleaning system; a thermal processing system such as a batch processing oxidation, diffusion, low pressure CVD furnace, or a thermal curing system; a rapid thermal processing (RTP) system, a lithography system; an ion implant system; a planarization system; an electro-plating system; a device probing system; a metrology system, etc.

As illustrated in FIG. 3A, an exemplary schematic illustration of a graphical user interface (GUI) is provided in order to highlight one or more service functions provided by the control system 20. For example, the GUI provides a service function key for repairing a process tool, i.e., a “Repair Machine” key.

According to one embodiment, the control system 20 collects service activity data from the process tool 10, and stores the service activity data. Service activity data generally includes data relating to services performed in semiconductor manufacturing, and more particularly relates to data relevant to correcting a fault in a semiconductor processing tool 10. For example, when a service operator provides service for the process tool 10, the service activity data, including but not limited to service repair date, service repair time, service repair type, service repair description, service repair test(s), service repair corrective action(s), and service repair reason, can be entered into the control system 20 and stored.

Other service activity data corresponding to a service operator for a process tool 10 can include the name of the service operator, the title of the service operator, the site where the service operator performs his or her primary duties (e.g., a manufacturing facility, customer site, etc.), the name of the supervisor, phone number, address, electronic mail address, reference files, photo files, etc.

Additionally, for example, other service activity data corresponding to a process tool 10 can include the type of MS platform, the model number for the MS platform, the serial number for the MS platform, the type of MS tool, the process associated with the specific MS tool, the model number for the MS tool, the serial number for the MS tool, the MS parts associated with the specific MS tool, the type of MS part, the model number for the MS part, the serial number for the MS part, the identification of the existence of spare parts, the identification of consumable parts, and MS part cost(s).

The correction of a fault in a semiconductor processing toll may result from an obligation under a service account or service agreement. Thus, other service activity data corresponding to a service agreement for a process tool 10 can include, for example, the agreement number, the title of the service agreement (e.g., one year 24×7 Parts & Labor Warranty), the coverage hours (24×7), an identification of the coverage items (e.g., non-consumables, repair labor, start up labor), an identification of the non-coverage items (e.g., consumables, customer damage), list price (e.g., the list price can be based upon existing service activity data in the control system), penalties (e.g., one month added for month below 93% availability), dedication of service operator to manufacturing facility, warranty or contract starting date, warranty or contract ending date, warranty or contract invoice date, warranty or contract payment date, etc. Service agreements can be assigned to process tools, as well as to manufacturing facilities (i.e., customers).

According to one embodiment of the invention, the control system 20 provides service activity data for performing a repair service function, such as isolating and correcting a fault as described above. For example, the control system 20 is configured to perform an interactive case study for service component repair. In this embodiment, the control system 20 can identify one or more cases pertaining to old service activity data where the new service activity data, associated with, for instance, a fault in the process tool 10, substantially matches the old service activity data, and utilize this correlation to assist a service operator in conducting the repair service, i.e., correcting the fault. As used herein, “matching service activity data” includes identical matching as well as approximate matching that may be defined by object oriented, rules-based or any other programming methods known to one of ordinary skill in the art. If necessary, the control system 20 can identify one or more tests to perform in order to narrow down the number of matching service activity data. Additionally, the test procedures, specific to the process tool 10 (e.g., MS platform and MS tool), can be made accessible to the service operator. The test procedures can be stored in the control system 20. As tests are performed and results are retrieved by the control system 20, the amount of matching service activity data is reduced. For instance, the control system 20 can assist in identifying the MS part to replace in the process tool 10 in order to correct the fault. Once the MS part is identified, a procedure, specific to the process tool 10 (e.g., MS platform and MS tool), can be made accessible to the service operator. The replacement procedures can be stored in the control system 20.

Referring again to FIG. 2A, this figure illustrates an exemplary operator interface for performing a service component repair using the control system 20,. In this example, the service operator has received a fault from a process tool, and has elected to utilize the interactive case study to isolate the fault and determine a corrective action for the fault. The fault can, for example, include a high reflected power on an impedance match network used for matching the output electrical impedance of a radio frequency (RF) generator with the input electrical impedance of a plasma processing system, such as an etch system. As seen in FIG. 2A, the service operator interacts with the control system 20, and activates the service component repair function by selecting the “Repair Machine” key.

Once activated, the operator interface of the control system 20 enables the service operator to identify the process tool (by, for example, MS platform serial number, or MS tool serial number), the type of process tool, and the process type in connection with the service account (or purchase account); see FIG. 2B. Thereafter, the control system can provide a list of the repair history for the identified process tool; see FIG. 2C. For example, as shown in FIG. 2C, the control system collects old service activity data from memory, and presents this old service activity data to the service operator. The service activity data can include the service date, service type, service description, and service reason. For instance, the service type indicates whether the service included a test, or included corrective action.

Furthermore, the control system 20 enables the service operator to identify the fault, or the test that failed; see FIG. 2D. In the embodiment of FIG. 2D, if the test failure (or fault) is a known fault, then it can be displayed on the left-hand side of the operator interface. If the test failure is not a known fault, the interface enables the service operator to enter the test failure.

Referring now to FIG. 2E, the service operator enters the results of the test failure reported from the process tool. This service activity data is stored in memory. Also shown in FIG. 2E, the control system provides some of the test plan data including, for example, the lower failure limit, the lower warning limit, the target result, the upper warning limit, the upper failure limit, the mathematical operator for comparing the target and actual results, the units of measurement, and whether the results are based upon opinion or not.

Referring now to FIG. 2F, the control system 20 searches its memory for other service activities (or cases) matching the current test failure, or fault. For example, the control system can present the tests and corrective actions performed for the current service activity (or case). Additionally, for example, the control system can present the tests, and corrective actions planned for the current service activity (or case). Additionally, for example, the control system can present the MS parts associated with the current service activity (or case). Additionally, the control system can present the tests completed on matching cases, as well as the corrective actions completed on matching cases. As illustrated in FIG. 2F, thirty (30) past cases match the current case. In the completed tests and corrective action list, the service operator can edit the results, add another completed test or corrective action to the end of the list, add another test or corrective action to the list of planned tests or corrective actions, review the test procedures for a specific MS platform, MS tool, MS part, or MS service agreement, review the test specifications for a specific test, or review the procedures for a specific corrective action. In the planned tests and corrective action list, the service operator can add the test or corrective action to the completed list, delete the test or corrective action, move the test or corrective action up or down in the list, review the test procedures for a specific MS platform, MS tool, MS part, or MS service agreement, review the test specifications for a specific test, or review the procedures for a specific corrective action.

For instance, the control system 20 can provide an interactive case study as described above, wherein the tests completed on the matching cases, and the corrective actions completed on the matching cases are itemized. For those tests completed on the matching cases, the control system can rank (or prioritize) the tests by indicating the number of cases that will be left if the test is performed and passes, as well as the number of cases that will be left if the test is performed and fails. For instance, when the mass flow controller for C₄F₈ process gas is tested, the number of cases remaining if the test passes is twenty-one (21), and the number of cases remaining if the test fails is seven (7). Furthermore, for those corrective actions completed on the matching cases, the control system can rank (or prioritize) the corrective actions by indicating the number of cases (or percentage (%) of cases) that will be corrected when the corrective action is performed, and the number of cases that will not be corrected when the corrective action is performed. For instance, when the mass flow controller for C₄F₈ process gas is replaced, the number of cases corrected were four (4), and the number of cases not corrected were zero (0).

Using the service action data presented by the control system (see FIG. 2E), the service operator can, for example, elect to perform a test. For instance, the service operator may perform one or more tests, and check the “Matcher Mode Setting”, the “PC Pressure Control”, and the “C4F8 Flow”. When the service operator has elected to perform one or more tests, and proceeds to perform these tests, the service operator can obtain test procedures for performing the test that is specific to the MS part, specific to the MS tool, and specific to the MS platform. In this example, this test results include a pass, pass, and fail, respectively, as shown in FIG. 2G. While performing these tests, the number of matching cases is reduced from thirty (30), to twenty one (21), to fifteen (15), to four (4). Additionally, the corrective actions on matching cases is reduced to a single action of replacing the C₄F₈ mass flow controller (MFC). Therefore, the service operator can elect to perform the corrective action by placing a request for the respective MS part, namely, a C₄F₈ mass flow controller; see FIG. 2H. Service activity data associated with the order of the MS part can be stored in the control system. The service activity data can, for example, include the MS part number, the quantity, the MS platform and its status, the MS tool and its status, the shipping information, the request information, the approval information, the service account, and the reason for replacement.

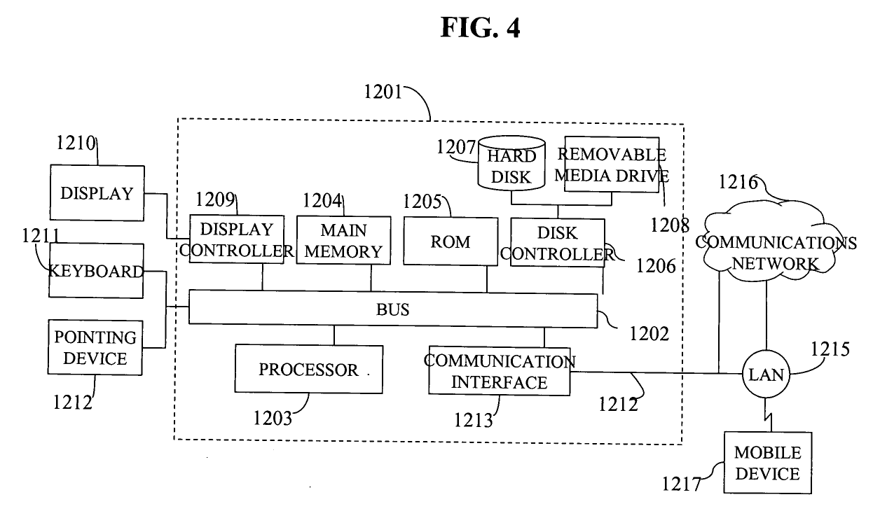

Referring now to FIG. 21, the control system can indicate the MS parts associated with the current case. For example, the MS part source, the MS part, the MS part number (P/N), the MS part serial number (S/N), and the MS part status can be presented. For instance, the MS part status can include “Ordered”, “Paid”, “Shipped”, “Installed”, or “Removed”. Once the MS part is requested, the MS part status can be amended, and proceed to indicate the MS part has “Shipped”, and has been “Paid” by a service account. On one end, a service operator is utilizing the control system to request a MS part, and on the other end another service operator is utilizing the control system to process the request including approving, shipping, etc. Additionally, once the MS part is received by the requester, the shipping status can be changed to received, and the MS part serial number can be entered by the service operator. FIG. 21 also indicates the tests and corrective actions planned for the current case. For instance, the C₄F₈ mass flow controller is to be replaced.

As shown in FIG. 2J, when the service operator has received the requested MS part, and proceeds to replace the MS part on the MS tool, the service operator can obtain instructions for replacing the MS part that is specific to the process tool. The corrective action procedures can be stored in the control system, and provided to the service operator via the control system. For instance, FIG. 2J illustrates a corrective action procedure for replacing the C₄F₈ mass flow controller. The corrective action procedure is specific to the MS part, and specific to the process tool.

Once the corrective action is completed, the control system is updated to reflect the changes; see FIG. 2K. For instance, the planned corrective action is moved to a completed corrective action, and the MS parts associated with the case are updated to show the removed MS part including MS part source, MS part, MS part number, MS part serial number, and MS part status. Thereafter, the service operator may proceed to re-check the tests which initially failed. For instance, in this case, the service operator re-checks test 51A5, and the C4F8 flow test. If the tests pass, as in this case, the control system 20 is updated to reflect these additional tests, and test results. The MS part can then be decontaminated, and scrapped, if elected to do so.

Anywhere during this service process described as a first example, another service operator, such as a service supervisor, can monitor the progress of a specific case. For example, if the interactive case study is not performed, and MS parts are sporadically replaced (i.e., “shot-gunning approach), the service supervisor can affect the service activity by denying payment on an MS part, instructing the service operator requesting the MS part to follow the interactive case study, etc.

Further details of service functions performed by a computer system are provided in co-pending U.S. patent application, entitled “Activity management system and method of using” (attorney docket no. 248132US), which is incorporated herein by reference in its entirety.

Referring now to FIG. 3, a method for correcting a fault in a semiconductor manufacturing system is described. The method is presented as a flow chart 100 beginning in 110 with collecting old service activity data for old faults in a process tool. The old service activity data can, for example, include the type of fault, the tests performed to diagnose the cause of the fault, and the corrective actions taken to attempt to correct the fault; all of which can be stored in memory for each fault. The old service activity data can be entered into a control system 20, for example, accessible to a service operator either manually, or automatically. Once the old service activity data is entered into the control system, it can be accessed either directly through an operator interface provided by the control system, or via an internet/intranet connection.

In 120, new service activity data is received for a new fault. The new service activity data is entered into the control system either manually, or automatically.

In 130, the new service activity data is compared with the old service activity data, in order to identify matching service activity data in 140. The matching service activity data is a form of service action data provided by the service function in order to assist a service operator in performing a service action such as correcting a fault.

In 150, a corrective action is determined and performed using the matching service activity data. The corrective action may include replacing a MS part in the process tool. Additionally, the method can include performing one or more tests in order to reduce the matching service activity data. For example, based upon old service activity data, one or more tests can be performed to narrow down the number of matching cases, and provide a reduced set of possible corrective actions to perform in order to correct the fault.

FIG. 4 illustrates a computer system 1201 upon which an embodiment of the present invention may be implemented. The computer system 1201 may be used as the control system 20 of FIG. 1 to perform any or all of the functions described above. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)). The computer system may also include one or more digital signal processors (DSPs) such as the TMS320 series of chips from Texas Instruments, the DSP56000, DSP56100, DSP56300, DSP56600, and DSP96000 series of chips from Motorola, the DSP1600 and DSP3200 series from Lucent Technologies or the ADSP2100 and ADSP21000 series from Analog Devices. Other processors especially designed to process analog signals that have been converted to the digital domain may also be used.

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data. communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214, and the communication interface 1213. Moreover, the network link 1214 may provide a connection through a LAN 1215 to a mobile device 1217 such as a personal digital assistant (PDA) laptop computer, or cellular telephone.

Although only certain exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. A method of correcting a fault in a process tool for semiconductor manufacturing comprising:
collecting old service activity data for old faults in said process tool;
receiving new service activity data for a new fault in said process tool;
comparing said new service activity data to said old service activity data;
identifying matching service activity data from said comparison; and
performing a corrective action based on said matching service activity data.

2. The method of claim 1, further comprising:
performing one or more tests on said process tool using said matching service activity data in order to generate new matching service activity data, wherein said new matching service activity data narrows said matching service activity data.

3. The method of claim 2, wherein said performing said one or more tests includes ranking each test in said one or more tests according to the number of old faults in said matching service activity data that are projected to remain if said ranked test results in a pass.

4. The method of claim 3, wherein the rank of said ranked test increases as the number of old faults in said matching service activity data that are projected to remain if said ranked test results in a pass decreases.

5. The method of claim 2, wherein said performing said one or more tests includes ranking each test in said one or more tests according to the number of old faults in said matching service activity that are projected to remain if said ranked test results in a fail.

6. The method of claim 5, wherein the rank of said ranked test increases as the number of old faults in said matching service activity data that are projected to remain if said ranked test results in a fail increases.

7. The method of claim 1, wherein said performing said corrective action includes replacing one or more manufacturing system (MS) part in said process tool.

8. The method of claim 7, wherein said replacing said one or more MS parts includes ranking each MS part replacement according to the number of old faults in said matching service activity data that are corrected upon replacement of said ranked MS part replacement.

9. The method of claim 8, wherein the rank of said ranked MS part replacement increases as the number of old faults in said matching service activity data that are corrected upon replacement of said ranked MS part replacement increases.

10. The method of claim 7, wherein said replacing said one or more MS parts includes ranking each MS part replacement according to the number of old faults in said matching service activity data that are not corrected upon replacement of said ranked MS part replacement.

11. The method of claim 10, wherein the rank of said ranked MS part replacement increases as the number of old faults in said matching service activity data that are not corrected upon replacement of said ranked MS part replacement decreases.

12. The method of claim 1, wherein said collecting said old service activity data for said process tool includes collecting old service activity data for at least one of an etch system, a deposition system, a track system, a thermal system, an ion implant system, a lithography system, a planarization system, a metrology system, and a test system.

13. The method of claim 1, wherein said performing a corrective action comprises automatically controlling said process tool to correct said fault therein.

14. The method of claim 1, wherein said performing a corrective action comprises providing service action data to a service operator to assist the service operator in correcting said fault in said process tool.

15. The method of claim 1, wherein said performing a corrective action comprises isolating said fault in said process tool.

16. A computer readable medium containing program instructions for execution on a processor, which when executed by the processor, cause a computer system to perform the steps in the method recited in claim 1.

17. A system for using a computer system to correct a fault in a process tool for semiconductor manufacturing comprising:
means for collecting old service activity data for old faults in said process tool;
means for receiving new service activity data for a new fault in said process tool;
means for comparing said new service activity data to said old service activity data;
means for identifying matching service activity data from said comparison; and
means for performing a corrective action based on said matching service activity data.

18. A system for correcting a fault in a process tool for semiconductor manufacturing comprising:
a memory configured to store data necessary for correcting said fault; and
a control system configured to:
collect old service activity data for old faults in said process tool,
receive new service activity data for a new fault in said process tool,
compare said new service activity data to said old service activity data,
identify matching service activity data from said comparison, and
perform a corrective action based on said matching service activity data in order to correct said new fault in said process tool.

19. The system of claim 18, wherein said control system is configured to perform one or more tests on said process tool using said matching service activity data in order to generate new matching service activity data, wherein said new matching service activity data narrows said matching service activity data.

20. The system of claim 18, wherein said process tool includes at least one of an etch system, a deposition system, a track system, a thermal system, an ion implant system, a lithography system, a planarization system, a metrology system, and a test system.
